(19) United States
(12) Patent Application Publication
(10) Pub. No.: US 2001/0005197 A1
(43) Pub. Date: Jun. 28, 2001

(54) Remotely controlling electronic devices

(76) Inventors: Animesh Mishra, Milpitas, CA (US); Jun Shi, San Jose, CA (US); Kenneth C. Curt, Saratoga, CA (US)

Correspondence Address: TROP PRUNER & HU, PC, 8554 KATY FREEWAY, SUITE 100, HOUSTON, TX, 77024, US

(21) Appl. No.: 09/785,919

(22) Filed: Feb. 17, 2001

Related U.S. Application Data
(63) Continuation of application No. 09/216,983, filed on Dec. 21, 1998.

(51) Int. Cl. H04N 7/14; H04M 11/00

(52) U.S. Cl. 345/100; 379/102.03; 348/14.05; 455/151.2; 348/734

(57) ABSTRACT

A control system enables telephone calls to be answered remotely using a remote control unit also adapted to remotely control an electronic device such as VCR. A processor based station may communicate with a remote control unit using both infrared and radio frequency protocols to enable remote telephone communications and remote control of electronic devices.

### BACKGROUND

This invention relates generally to remotely controlling electronic devices.

There are a very large number of commercially available remote control units (RCUs) that use an infrared signal to control an electronic device such as a television. Many users have elaborate systems of consumer electronic devices which may or may not be compatible with one another. For example, in a home theatre environment, the user may have a stereo sound system, a television, a video cassette recorder (VCR), a laser disc player and a digital video disc player (DVD). The user may desire to control each of these devices independently with a single RCU so that one device may be played when the others are off. This requires programming a number of functions into the RCU including on/off, channel change, volume change, program VCR and the like.

With conventional RCUs in systems with a number of electronic devices to be controlled, the programming operation may be extremely elaborate and time consuming. The user enters each device and programs the desired functionality into the RCU. The situation is complicated by the use of Infrared Data Association Control (IrDA-C) protocols. These protocols involve bidirectional signals which may not be compatible with the legacy infrared control signals which are unidirectional infrared signals. Thus, different devices may use different infrared protocols and may require different command sets to operate them. All of this results in complexity to the user in programming the remote control to handle all of these possibilities.

The user may also wish to remotely control a computer system that operates in conjunction with a conventional television receiver. Computer systems, sometimes called set-top computer systems, may be of relatively small size, in some embodiments, and may be positioned on top of a television receiver. The addition of the set-top computer system adds still additional programming requirements on the remote control, further complicating user programming of a universal remote control which handles all of the different electronic devices. For example, the computer system may use the bidirectional IrDA protocols while some other electronic devices may use the unidirectional legacy protocols.

Thus, there is a continuing need for a way to program a remote control unit to handle a variety of electronic devices in a fashion which is easy and quick for the user.

### SUMMARY

In accordance with one aspect, a remote control unit includes a control device adapted to remotely control an electrical device. The remote control unit also includes a telephone unit adapted to enable remote communication with a telephone unit.

### BRIEF DESCRIPTION OF THE DRAWINGS

FIG. 1 is a schematic depiction of one embodiment in accordance with the invention;

FIG. 2 is a block diagram of a remote control unit shown in FIG. 1;

FIG. 3 is a flow chart for an embodiment such as the one shown in FIG. 1;

FIGS. 4a through 4c are depictions of graphical user interfaces useful with the embodiments shown in FIGS. 1 and 2;

FIG. 5 is a flow chart for the telephone set-up software in one embodiment of the invention;

FIG. 6 is a flow chart of one embodiment of software for enabling telephone communications through a remote control unit; and

FIG. 7 is a block diagram showing the set-top computer system shown in FIG. 1.

### DETAILED DESCRIPTION

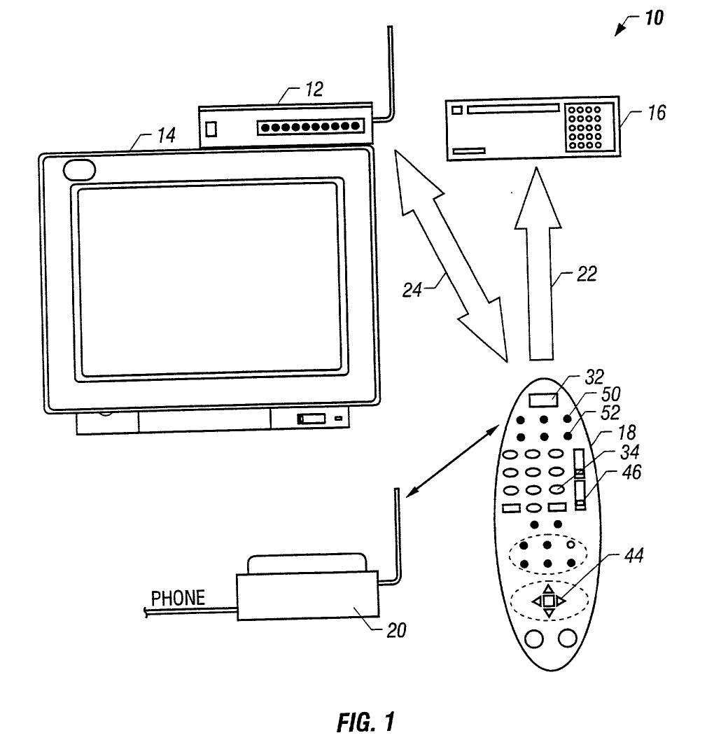

A control system 10, shown in FIG. 1, includes a processor-based system 12 that communicates with a remote control unit (RCU) 18. The system 12 may be a so-called set-top computer system that may work together with a conventional television receiver 14.

The RCU 18 may include a display 32, keypad 34 and a joy stick type navigation control 44. In addition, the RCU 18 may include a telephone off hook button 46 and buttons 50 and 52 that act as “on” and “off” controls for dedicated electronic devices such as the audio/visual receiver 16.

The RCU 18 may also communicate with a telephone base station 20 which may be coupled to a telephone line. The RCU 18 may include a telephone receiver. The RCU 18 may include buttons which enable the user to receive an incoming call through the RCU and to provide an off hook signal. The RCU 18 may communicate with the system 12 and a radio-frequency telephone base station 20 using radio-frequency technology. For example, a 27 MHz or a 900 MHz carrier frequency may be used.

Thus, when an incoming telephone call is detected, the RCU 18 may “answer” the telephone call either by communicating using a radio-frequency system with the base station 20 (with the telephone receiver removed) or the system 12. While a radio-frequency based system is illustrated, other wireless and wired techniques may be used as well including infrared techniques.

The RCU 18 may communicate with the system 12 using wireless communication such as infrared or radio-frequency links. The infrared link may use the IrDA-C bidirectional signals as one example. The system 12 may communicate with the RCU 18 using a wired or wireless communication of the type described previously.

A repeater may be provided in the RCU 18. The repeater, in one embodiment of the invention, may receive an IrDA-C bidirectional infrared signal and selectively output either a bidirectional or a unidirectional infrared signal. Since many infrared controlled electronic devices, such as televisions and VCRs, use unidirectional infrared systems, in some embodiments it is advantageous to convert the bidirectional signal to a unidirectional signal using a repeater provided, for example, by the RCU 18. For example, communication between the system 12 and RCU 18 may use bidirectional protocols while commands issued by the RCU 18 to the device 16 may use the unidirectional protocol.

Having received a command signal from the RCU 18, the system 12 can translate the command into a format appropriate for controlling a particular device 16. That is, it is not necessary to program the RCU 18 independently. Instead, a variety of codes may be stored in the system 12. The user may be called upon to indicate the type of devices which need to be controlled. When the RCU transmits a signal corresponding to a known function (which signal may not be particularly adapted to work any particular device), the system 12 can translate that signal and send information back to the RCU 18 to enable the RCU 18 to control the particular device the RCU 18 is to operate.

In this way, it is not necessary to undergo elaborate programming of the RCU 18, but instead, databases within the system 12 may contain information about how a conventional device 16 may be operated. In addition, the RCU 18 may be used not only to control device 16 but also to answer the telephone 20 as well.

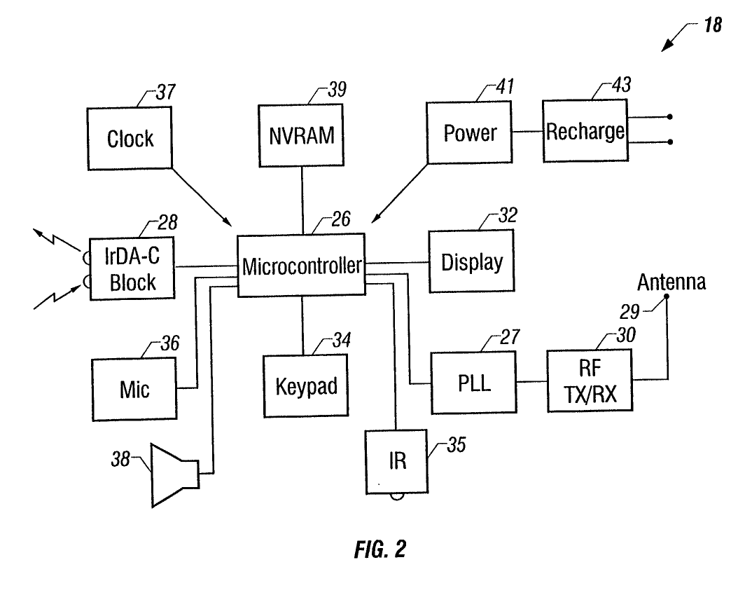

Referring to FIG. 2, the RCU 18 may include a display 32 which in one embodiment of the invention may be a liquid crystal display. It may be useful, for example, for displaying the telephone number dialed from the RCU 18. A controller 26 may be coupled to a memory 39 and may be responsible for controlling the display 32 as well as an RF transceiver 30. The controller 26 may be processor-based and may be a microcontroller or a microprocessor, as examples. The RF transceiver 30 may send radio frequency voice information to the telephone base station 20 or to the system 12. The transceiver, in one embodiment of the invention, uses an internal antenna 29 that may be built into the RCU 18. The IR transceiver 28 may be used to communicate with the system 12 using a bidirectional infrared protocol such as the IrDA-C protocol in one embodiment of the invention. The IR transmitter 35 may be used to communicate with legacy devices 16 using a unidirectional protocol in one embodiment.

The controller 26 may also control the keypad 34 for allowing user input commands. A microphone 36 and speaker 38 enable telephone functions. A clock 37 and battery power supply 41 may also be provided. The power supply 41 may be removably coupled to a recharger 43 that may be contained, for example, in the system 12. While coupled to the system 12, the RCU 18 may be recharged. Advantageously, in some embodiments, RCU subsystems may enter a powered down mode when not in use. For example, the internal IR repeater modules 28 and 35 (if provided) may be powered down during RF (telephone) communications and vice versa.

A phase locked loop device 27 may be used to tune the RF transceiver 30 to a particular wireless telephone technology. For example, the user may be prompted to indicate what wireless technology (if any) is currently being used in the user's existing telephone system. For example, the user may then enter information that the user's telephone system uses a particular carrier frequency such as 27 MHz or 900 MHz.

The PLL 27 is tuned to the particular frequency used by the model and brand of wireless telephone currently owned by the user. This tuning may be done in a number of ways. As one example, the page feature on many wireless phones may be activated to produce an RF carrier tone. The PLL 27 then frequency locks on the particular frequency of the user's telephone. The transceiver communicates this frequency to the system 12 which locks to the same frequency. In this way, existing wireless telephones may be used with the system 12.

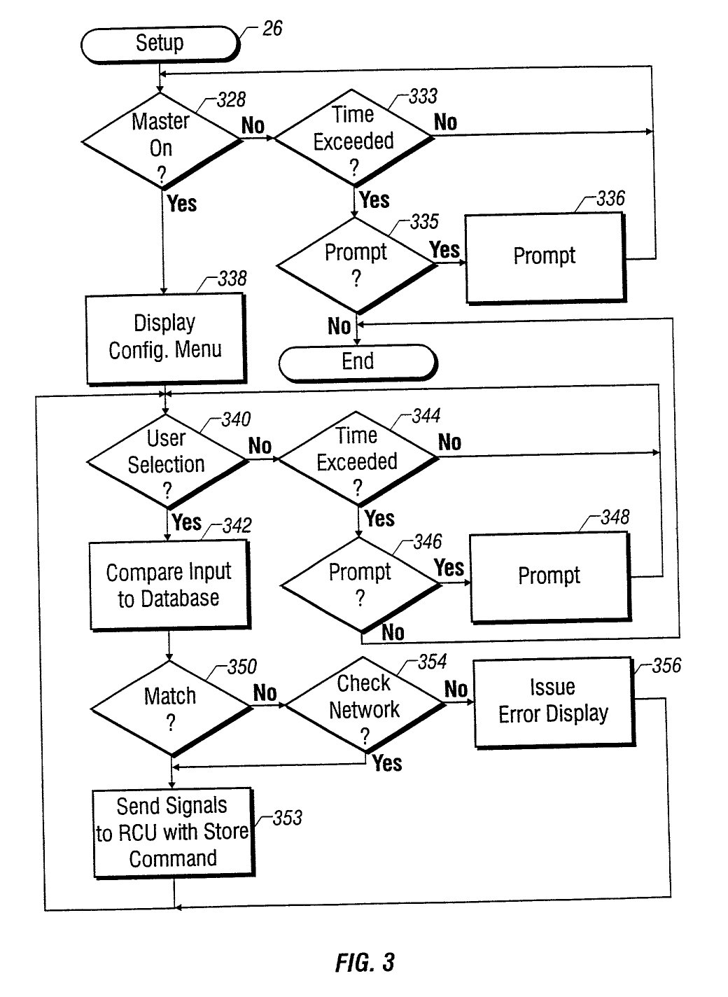

Referring now to FIG. 3, set-up software 26, which may be resident on the system 12, for allowing automatic control of electronic devices may begin in one embodiment of the invention by determining whether a master (which may be the system 12) has been turned on by a slave (which may be the RCU 18) as determined in diamond 328. If so, the receiver 14 or another display device may be caused to display a configuration menu, as indicated at block 338.

If the master has not been turned on by the slave, a check at diamond 333 determines whether a preset time limit has been exceeded. If not, the flow cycles back to wait for the operation of the master by the slave. If the time period has been exceeded, a check at diamond 335 determines whether a prompt should be provided. If the elapsed time exceeds still another limit, the prompt may not be provided and the flow may be terminated.

Otherwise, the prompt may be provided (block 336) as a graphical user interface, for example, asking the user to operate the master using the remote control. This may involve turning the master back off and operating it “on” using the remote control.

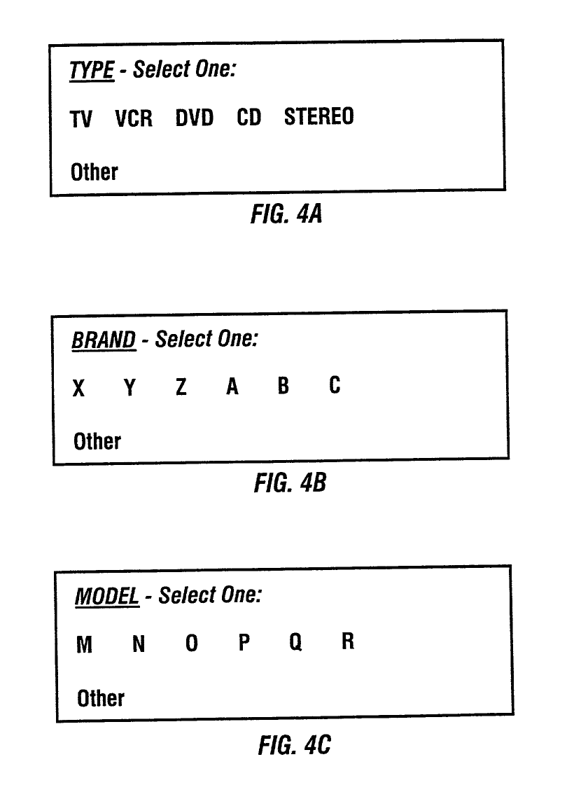

The configuration menu may allow the user to input the type of devices which the user wishes to automatically control using the RCU 18. For example, referring to FIG. 4a, a graphical user interface, displayed on the television receiver 14, may ask the user to input the type of device, be it a TV, a VCR, a DVD, a CD or a stereo system. Otherwise, the user can input “other” and an additional drop-down menu may be provided or the user may be asked for additional information.

Once the user has selected the device type, in one embodiment of the invention, the system may automatically provide a list of common manufacturers of the type of device selected using a database provided with the system 12, as illustrated in FIG. 4b. Again, the user has the option to select “other”, and when “other” is selected, the system may either access additional information or display an additional menu of other manufacturers.

Referring to FIG. 4c, a graphical user interface may also ask the user to select from among the models available for the given type of device and the selected manufacturer. The user again may select the desired option or may be provided with additional options by selecting the “other” option.

The user may input the selections using the RCU 18. This may be done using a mouse style pointing system or, if desired, each potential selection may be associated with a number or a letter which then may be entered using the keypad provided on the RCU 18.

Referring back to FIG. 3, at diamond 340 a check determines whether the user has made all of the required selections. If so, each selection is compared to a database of known information (block 342). From the database, the required remote control codes can be determined by the system. If there is no user selection and a time period has elapsed (diamond 344), a check at diamond 346 determines whether to provide a prompt (block 348).

If each of the selections matches an existing database entry (diamond 350), the appropriate signal information is sent to the RCU 18 by the system 12 (block 353). In other words, the RCU 18 may be provided with protocols to control a given device. Referring to FIG. 1, the information may be provided along the path 24 from the system 12 to the RCU 18, thereby enabling the RCU 18 to control the device 16 as indicated at 22. The RCU 18 may also be commanded to store the information in an appropriate format on the RCU 18.

If the user selections do not match any existing database entries for known devices, a network check may be initiated as indicated at diamond 354. In this case, the system 12 may communicate with an external network, for example over a modem connection, to determine whether additional information is available. This modem connection may connect to an additional database, for example over a direct telephone link to a server or over the Internet. In such case, additional information about the requested device may be downloaded to the system 12 allowing the system 12 to proceed, as indicated in block 353, to provide the RCU with the desired information. If no such information can be located, a graphical user interface indicating an error condition may be displayed, as indicated at block 356. In this case, the user may be prompted to program the device in the conventional fashion since the system is unable to automatically provide the information to the RCU 18.

In some embodiments, the tedious task of programming the various devices may be performed in an automated fashion using the databases and software associated with the system 12. This operation may occur seamlessly and without substantial user involvement in the programming of the RCU 18.

The RCU 18 may operate in one of at least two different fashions. The RCU may have dedicated buttons that correspond to particular controlled devices. For example, the RCU may contain a button that is labeled “TV.” When the TV button is pushed, the appropriate commands are sent to the master informing the master that the user now wishes to control the TV. The next button that is pushed, for example, the channel up button, causes the appropriate command to be sent to the master telling it, for example, that the user wishes to go to the next highest channel. The master in turn sends the RCU the necessary codes to increment the channel on the TV. The RCU then takes these codes and sends them, for example using a unidirectional infrared signal, to the TV using the protocols stored in the RCU's memory.

Alternatively, the RCU may contain sufficient memory that the master may send the RCU both the protocols and the necessary codes to control the devices. The RCU saves this information in its local memory. Then, when the user wishes to change the channel on the TV, the user pushes the TV button and this causes the RCU to enter a mode which controls the TV using the pre-sent protocols. Then, when the user pushes the channel up or other control button, the remote control may fetch the necessary codes from local memory and send a unidirectional infrared message, for example, using the protocol that is also stored locally on the RCU.

The difference between the two approaches is that in the first case, the master feeds the information to the RCU each time the RCU needs information. In the second case, the master feeds the information needed to do all the different controls for a given device initially, and then the device handles those protocols on its own. In one embodiment of the invention, the information may be provided from the master to the RCU each time the system is operated so that it is not necessary to discard the information when it is desired to switch controlled devices.

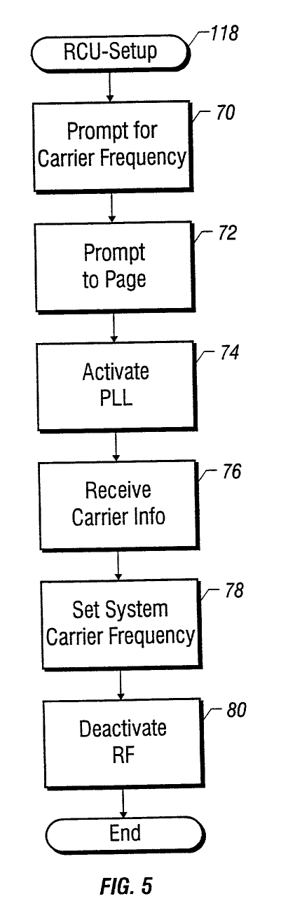

In the telephone set-up mode (FIG. 5), the user is prompted (block 70), using a graphical user interface for example, to input a radio carrier wave frequency, which might be, for example 27 MHz or 900 MHz as conventional examples. The user may be prompted to input this information directly or alternatively to input wireless telephone brand and model information. This information may be transmitted from the RCU to the system 12. At the system 12, the telephone data may be compared to a database that correlates model and brand information to carrier frequency.

Next, the user may be prompted to generate a signal from the user's wireless telephone system (block 72). This may be done, for example, by operating the page feature and activating the PLL lock circuit 27 (block 74). The RCU 18 may detect the page and automatically analyze its carrier frequency using a PLL lock circuit 27, for example. The carrier frequency information may then be transmitted to the system 12. Even if the user inputs model and brand information it may be desirable in some cases to tune the lock circuit to the actual carrier frequency.

The system 12, having identified the carrier frequency of the user's existing wireless telephone system (block 76), may then cause the system 12 (and RCU 18) to adapt to the frequency of the existing system (block 78). This may be useful, for example, in allowing the system to operate through an existing telephone base station as desired, for example, when the system 12 is out of range. Once the system 12 is tuned to the existing wireless telephone system (if any), the RF sections of the RCU may be deactivated for power saving (block 80).

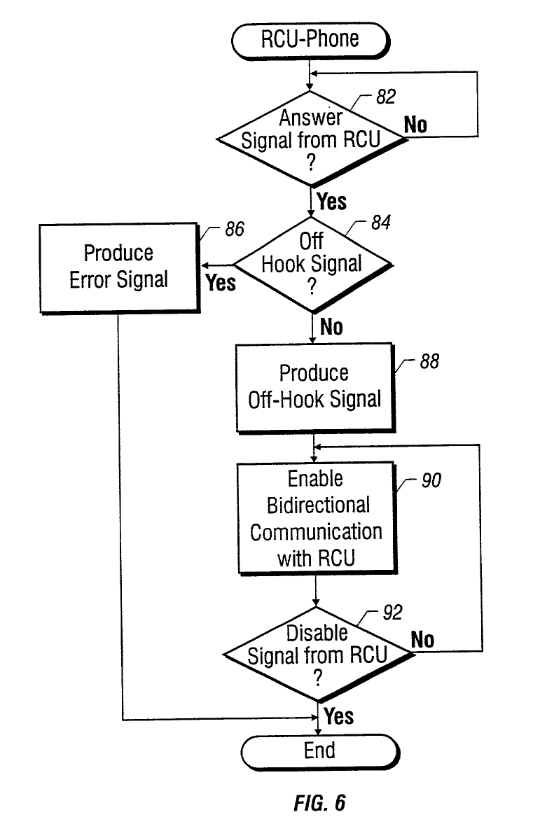

When a telephone call is received, the system 12 awaits a command from the RCU to answer the call as indicated at diamond 82 in FIG. 6. Once the command is received, the system 12 may determine whether an off hook signal has already been provided (diamond 84), for example by someone else picking up the handset of another telephone. If so, the user may be notified (block 86).

Otherwise, the system 12 produces an off hook signal (block 88) and enables bidirectional communication with the RCU (block 90). This may be done, for example, by activating the RF transceiver 30 of the RCU. The user may then use the RCU as a telephone handset.

When the user has completed the call, a button 46 may be operated terminating the call (diamond 92). This information is transmitted, by an IR command signal, for example, to the system 12 which disables the off hook signal and returns the telephone system to a state to receive an incoming call.

The system 12 may be equipped with a caller identification delivery (CID) decoder. Information about the source of the incoming call may be displayed on the television receiver and on the display 32, for example. To make an outgoing call the switch 48 may be operated and a signal is sent to the system 12 which produces as off hook signal and makes a connection to a telephone network.

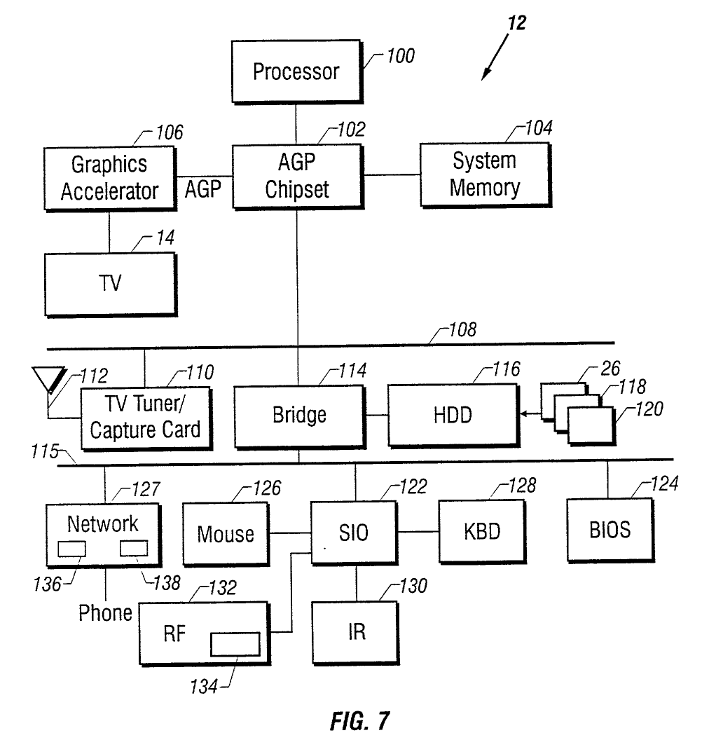

Referring now to FIG. 7, an example of a system for providing the capabilities described previously may involve either a computer, a television receiver, a set-top computer system or another appliance. The illustrated system 12 includes a processor 100 coupled to an accelerated graphics port (AGP) chipset 106. AGP is described in detail in the Accelerated Graphics Port Interface Specification, revision 2.0, published in 1998 by Intel Corporation of Santa Clara, Calif.

The AGP chipset 102 may in turn be coupled to system memory 104 and a graphics accelerator 106. The graphics accelerator 106 may be coupled to a TV receiver 14.

The chipset 102 may also coupled a bus 108 which in turn may be coupled to a TV tuner/capture card 110. The tuner/capture card 110 may be coupled to a television input 112. The input 112 may, for example be a conventional TV antenna, a satellite antenna, a cable connection, or other television inputs. The card 110 may receive television signals in one video format and may convert them into a format used by the system 12.

The bus 108 may also be coupled to another bridge 114 which in turn couples a hard disk drive 116. The hard disk drive 116 may store the software 26, the software 118 for the telephone setup and the software 120 necessary to download additional information from a network.

The bridge 114 may be coupled to a bus 115 in turn coupled to a Serial Input/Output (SIO) device 122 and a Basic Input/Output System (BIOS) 124. The SIO device 122 may interface to a mouse 126 and a keyboard 128, and IR interface 130 and RF interface 132. The IR interface 130 couples the system 12 to the RCU 18. The infrared interface 130 may, for example, be in accordance with the Infrared Data Association protocols such as, for example, the Serial Infrared Physical Layer Link Specification, version 1.2, dated Nov. 30, 1997.

The RF interface 132 may be coupled to an antenna for RF communications with the RCU 18. The interface 132 may include a PLL 134 that may be tuned to the carrier frequency of the user's existing wireless telephone. Alternatively, the PLL 134 may be tuned to a frequency detected by the RCU 18 or to a frequency provided by the user.

The bus 115 may also coupled a network interface which may include a voice modem that may be coupled to a telephone line. In one embodiment, the interface 127 may also include a caller identity delivery (CID) detector 136 and a device 138 for producing an off hook signal to a telephone network.

The graphical user interfaces described herein are visual representations of memory states. The graphical user interfaces displayed on the display 14 may be stored in a memory such as one or more of the memories 104 or 116.

While the present invention has been described with respect to a limited number of embodiments, those skilled in the art will appreciate numerous modifications and variations therefrom. It is intended that the appended claims cover all such modifications and variations as fall within the true spirit and scope of the present invention.

What is claimed is:

1. A remote control unit comprising:
a control device adapted to remotely control an electronic device; and
a telephone unit adapted to enable remote communication with a telephone network.

2. The remote control unit of claim 1 wherein said control device includes:
a receiver that receives an infrared command signal in a first format; and
a transmitter that transmits an infrared command signal in a second format.

3. The remote control unit of claim 1 wherein said telephone unit includes a transceiver adapted to remotely communicate with a telephone network.

4. The remote control unit of claim 3 wherein said transceiver is a radio frequency transceiver tunable to the carrier frequency used by another wireless telephone.

5. The remote control unit of claim 4 wherein said telephone unit includes a device which is automatically tuned to the carrier frequency of another wireless telephone.

6. The remote control unit of claim 1 including a repeater for forwarding a wireless transmission received by a first device to an electrical device.

7. A remote control system for an electronic device comprising:
a first device including a processor and a radio frequency transceiver and an infrared transceiver, said processor arranged to control said infrared and radio-frequency transceivers; and
a remote control unit including a device adapted to remotely control an electronic device and a telephone unit adapted to enable remote communication with a telephone network.

8. The remote control system of claim 7 wherein said telephone unit includes a radio frequency transceiver adapted to remotely communicate with said telephone network.

9. The remote control system of claim 8 wherein said transceiver is tunable to the carrier frequency used by another wireless telephone.

10. The remote control system of claim 9 wherein said telephone unit includes a device which is automatically tuned to the frequency of another wireless telephone.

11. The remote control system of claim 7 including a repeater for forwarding a wireless transmission received from the first device to said electronic device.

12. The remote control system of claim 7 wherein said first device and said remote control unit are adapted to communicate both by radio frequency and infrared signals.

13. The remote control system of claim 12 wherein said first device and said remote control unit communicate via bidirectional infrared signals and said remote control unit communicates with said electronic device using unidirectional infrared signals.

14. The remote control system of claim 7 wherein said remote control unit is adapted to act as radio frequency transceiver for telephone communications with said first device.

15. The remote control system of claim 7 wherein said first device is a set-top computer system.

16. A method of completing a telephone call comprising:
enabling a user to receive a telephone call on a remote control unit; and
enabling the user to control an electronic device using said remote control unit.

17. The method of claim 16 further including using a processor based system that detects an incoming call and produces an off hook signal.

18. The method of claim 17 further including converting signals from a telephone network into radio frequency signals and transmitting said signals to the remote control unit.

19. The method of claim 18 further including detecting the carrier frequency of a proximate wireless telephone and adopting said frequency as the carrier frequency for communications with said remote control unit.

20. An article comprising a medium for storing instructions that cause a processor based system to:
enable a user to receive a telephone call on a remote control unit; and
enable the user to control an electronic device using said remote control unit.

21. The article of claim 20 including instructions that cause a processor based system to prompt for a wireless telephone carrier frequency.

22. The article of claim 20 including instructions that cause a processor based system to prompt the user to issue a page from the user's wireless telephone.

23. The article of claim 20 including instructions that cause a processor based system to use the carrier frequency of another wireless telephone.

24. The article of claim 20 including instructions that cause a processor based system to produce a telephone off hook signal when an incoming call is detected.

25. The article of claim 20 including instructions that cause a processor based system to receive infrared command signals in one format and to transmit infrared command signals in a second format.
